(19) United States
(12) Patent Application Publication
(10) Pub. No.: US 2026/0213599 A1
(43) Pub. Date: Jul. 23, 2026

(54) ELECTRIC COIL AND METHOD OF MANUFACTURING AN ELECTRIC COIL

(71) Applicant: Rolls-Royce Deutschland Ltd & Co KG, Blankenfelde-Mahlow (DE)

(72) Inventors: Peter GRÖPPEL, Erlangen (DE); Theo KAFFENBERGER, Weinheim (DE); Markus WILD, Nürnberg (DE)

(21) Appl. No.: 19/142,388

(22) PCT Filed: Dec. 18, 2023
(86) PCT No.: PCT/EP2023/086430

§ 371 Date: Jun. 23, 2025

(30) Foreign Application Priority Data
Dec. 23, 2022 (DE) 10 2022 134 667.6

(51) Int. Cl. H02K 3/32; H02K 1/14; H02K 3/18; H02K 3/34; H02K 15/043; H02K 15/065; H02K 15/122

(52) U.S. Cl. CPC H02K 3/325; H02K 1/14; H02K 3/18; H02K 3/345; H02K 15/0431; H02K 15/065; H02K 15/122; H02K 2203/12; H02K 2215/00

(57) ABSTRACT

An electrical coil includes a winding wire that is wound to form a plurality of coil turns. The winding wire has a strand that includes a multiplicity of thin, twisted individual wires, and the strand is sheathed with a turn insulation. Additionally, a fixing band is wound around the coil turns in at least one portion, wherein the fixing band, when the coil has been compressed, locally encases and geometrically fixes the coil turns. The disclosure also relates to the associated method for producing the electrical coil for a single tooth of a stator, wherein the coil is produced on a dummy winding body and is subsequently mounted onto the tooth.

The present patent document is a § 371 nationalization of PCT Application Serial No. PCT/EP 2023/086430, filed Dec. 18, 2023, designating the United States, and this patent document also claims the benefit of German Patent Application No. 10 2022 134 667.7, filed Dec. 23, 2022, which are incorporated by reference in their entireties.

### TECHNICAL FIELD

The disclosure relates to an electrical coil according to the preamble of patent claim 1 and to a method for producing such an electrical coil.

### BACKGROUND

There is a need to improve electric motors in respect of the target variables of efficiency, power to weight ratio, reliability and service life, with the target variables being partially in conflict with one another. There is such a need especially in applications in the aerospace industry, in which the future of aircraft electrification depends decisively on the power density of the motors and generators to be used. In this context, increasing the continuous power density of electric motors is decisively limited by the current with which the electric motor may be operated. This is affected inter alia by the conductor density and the associated copper fill factor.

To provide compact coils that are used in electric motors, the use of strands is known, these being produced from a multiplicity of thin, twisted round wires. Coils for electrical machines using strand technology are described in DE 44 14 527 C1 and WO 2004/059817 A1, for example.

In contrast to copper flat conductors, stranded conductors have a lower copper fill factor since they are constructed from individual wires, wherein a theoretical maximum copper percentage of 78% is obtained for round individual wires. In reality, this value is significantly undershot since the distribution of the individual wires does not correspond to the densest packing possible, and the free volume increases on account of the winding, the twisting of the individual wires and the internal stresses of the strand.

There is a known practice of compressing winding wires produced from strands after winding to form a multi-layer coil in order to increase the copper fill factor. However, compression of the strands may have a negative effect on the insulating properties since the individual wires and the insulation thereof may be damaged by high mechanical loads, or impregnation of the coil with a resin may be made more difficult by the compression.

US 2010/0193506 A1 discloses an electric coil having a strand as the winding wire, which forms a plurality of coil turns, wherein the coil turns are compressed and fixed by holding tapes.

EP 3 201 932 B1 discloses a method for producing a coil, in which a wire is wound onto a coil former and then compressed in a die by an upper punch part.

EP 2 804 292 A1 discloses a preformed coil for producing a self-supporting air gap winding. Here, forming faces of two tool bodies, which may move relative to one another along an axis of rotation, define a winding gap for bending a wire element in a form-imparting manner.

DE 10 2008 016 488 A1 discloses a coil having at least four electrical lines, which are wound around a common winding center. In order to wind the lines, use is made of two pressing rollers, which are arranged at an angle of 90° with respect to one another and which press the electrical lines onto guides of a guide roller.

### SUMMARY AND DESCRIPTION

The object on which the present disclosure is based is that of providing a coil which is produced from a winding wire including strands and is distinguished by a high copper fill factor. It is furthermore sought to provide a method for producing such an electrical coil.

Accordingly, in a first aspect, a coil is provided that has a winding wire that is wound to form a plurality of coil turns. In this case, the winding wire has a strand that includes a multiplicity of thin, twisted individual wires. Moreover, the strand is sheathed with a turn insulation.

The coil turns are wound in at least one portion with a fixing tape, which, in the compressed state of the coil, locally envelops and geometrically fixes the coil turns.

The solution is based on the concept of fixing the electrical coil in the compressed state thereof and thereby preventing the coil from spreading out again after the removal of the compression pressure. Preventing this provides that the high copper fill factor achieved when compressing the coil is maintained and that the copper fill factor does not then decrease again when the compression pressure is removed. A high copper fill factor of the coil based on a stranded winding wire is thereby provided on a permanent basis.

To fix the electrical coil in the compressed state thereof, at least one fixing tape is provided, which is wound around the coil turns locally in at least one portion. The fixing tape geometrically fixes the coil turns and, in particular, prevents the coil turns from spreading out. The use of the at least one fixing tape provides stability of shape of the coil and defined dimensions.

The fixing tape surrounds the coil only locally or in some portions, not completely. Otherwise, final impregnation of the coil with a resin would not be possible, or not to a sufficient extent. The solution thus makes it possible to provide stability of shape of the coil combined with the possibility of impregnation.

In certain examples, the fixing tape includes a cured composite material, wherein the fixing tape is flexible before it is cured and it may therefore be wound around the coil turns before it is cured. One example of this is a fixing tape that is not adhesive at room temperature, melts with a high viscosity at an elevated temperature, and then cures after a short time. Such tapes are also referred to as B-stage tapes or B-stage epoxies. One example of this is the material “Voltafix 2102” made by Isovolta Group, which is constructed as an epoxy resin/glass fiber composite. Other pre-impregnated fibers (prepregs) may also be considered as a material for the fixing tape.

Each individual wire of the strand may be provided in a manner known per se with an insulation, providing that there is no flow of current between the individual wires of the strand. Provision may furthermore be made for the individual wires of the strand each to be provided with a baked enamel coating. A baked enamel coating forms a fusible and curable coating of the individual wires. Here, the coating of baked enamel surrounds the individual wire insulation of the individual wires of the strand. In certain examples, the baked enamel cures together with the fixing tape, as explained in the context of the production method described herein.

In one example, the coil turns are locally fixed by a plurality of fixing tapes, which are spaced apart, with the result that free regions without a fixing tape are formed between the fixing tapes. In this context, provision is made, for example, for the coil turns to be locally enveloped by a fixing tape in the region of a straight leg of the coil, wherein it is also possible for a plurality of fixing tapes to be provided for each leg of the coil.

The fixing tape is initially wound around the coil turns and then cures. In a coil portion under consideration, the fixing tape surrounds all the coil turns of the coil. In certain examples, the fixing tape rests directly on the coil turns.

The strand is provided with a turn insulation that forms the outer sheath of the winding wire. In certain examples, the turn insulation includes a porous compressible or compressed material that is electrically insulating. In this case, the turn insulation is configured to be sufficiently porous to be able to absorb a resin during impregnation of the coil. This allows subsequent thorough impregnation of the strand including the individual wires and the turn insulation itself.

At the same time, the material of the turn insulation is compressible, i.e., its volume may be reduced under a compression pressure. This is advantageous in order to increase the copper fill factor within the winding wire when the coil or winding wire is compressed. Even in the compressed state, when the turn insulation is compressed to the maximum extent, it nevertheless has electrically insulating properties, thus ensuring that the coil turns are reliably insulated from one another. Moreover, the porosity of the turn insulation is maintained in the compressed state of the coil. The turn insulation is wound as tape-like material, for example, around the strand.

The turn insulation may include woven materials of sufficient temperature stability, which are constructed, for example, on the basis of polymers such as aramid fibers, PBO fibers, polyester fibers, nylon fibers, PTFE, etc. Inorganic fibers, (e.g. glass, quartz, ceramic fibers, or basalt fibers), or natural fibers also come into consideration.

Such materials may be used in the form of continuous fibers as woven or non-crimp fabrics but also as staple fibers in the form of nonwovens. The use of porous standard insulating materials, e.g., those made of m-aramid fibers, is also possible.

The turn insulation is impregnated with a resin when the coil is applied to a winding former such as a laminated stator core, wherein the resin also surrounds the strand, including the individual wires of the strand, and the coil is thus thoroughly impregnated with the resin.

In certain examples, a rectangular cross section is imparted to the winding wire during compression, such that it has a rectangular cross section in the coil. This makes it possible to provide a high copper fill factor in view of the compactness of the turn windings.

In another aspect, an electrical machine having a rotor and a stator is disclosed, wherein the stator has coils as described herein, which are each applied to a winding former of an individual tooth of the stator. The electric motor is, for example, a permanent magnet synchronous motor. In the case of a permanent magnet synchronous motor, the stator is fitted with coils, while surface-mounted permanent magnets are mounted on the rotor.

In a further aspect, a method for producing an electrical coil is provided. The method includes winding a winding wire, which includes a strand having a multiplicity of thin, twisted individual wires and is provided with a turn insulation, to form a coil having a multiplicity of coil turns, wherein the winding wire is wound onto a dummy winding former. The method further includes compressing the coil at least in the direction of the coil axis, wherein the strands of the winding wire are compacted and the individual coil turns are pressed against one another, with the result that the coil assumes a compacted state. The method further includes winding at least one curable fixing tape around the coil turns before or after compression. The method further includes curing the fixing tape, wherein the cured fixing tape fixes the coil in the compacted state.

The method is based on the concept of arranging a fixing tape locally on the outside of the coil and compressing the coil, wherein the fixing tape cures in the compressed or compacted state of the coil and thereby fixes said coil in the compressed or compacted state. A permanently high copper fill factor of the coil is thereby provided.

Here, the compression of the coil includes compacting the strands of the winding wire, wherein the turn insulation is also pressed together in order to enable compaction of the strands. This is carried out in such a way that the functioning of the turn insulation is maintained and it also continues to have sufficient porosity to absorb an impregnating resin in a subsequent act. The compression of the coil further includes pressing the individual coil turns against one another, such that no cavities exist between the individual turns.

The compression of the coil in the direction of the coil axis takes place in a vertical direction, for example, if the coil is aligned perpendicularly. Compression is effected, for example, by reducing the distance between parallel plates in the vertical direction, pressing the coil turns together in the process. In addition, the compression of the coil may also take place perpendicularly to the coil axis, e.g., in a horizontal direction. This too may be accomplished, for example, by shortening the distance between parallel plates, with the coil turns being pressed together in the horizontal direction, e.g., being pressed against a winding former.

After curing of the fixing tape, the coil may be removed from the dummy winding former and applied to a winding former of an individual tooth, wherein the winding former of the individual tooth includes a laminated core, for example, and the coil may be inserted into a slot of the laminated core. Here, the coil is in the form of a toothed coil winding (also referred to as a concentrated winding). A plurality of such tooth-wound coils or individual teeth may be combined to form an annular stator of an electrical machine.

The winding of the at least one curable fixing tape around the coil turns may take place before or after compression. If the fixing tape is wound around the coil turns before compression, compression takes place in one act. If the fixing tape is wound around the coil turns after compression, compression takes place in two acts. In the text below, the second case will be considered first.

Compression of the coil in two acts involves the following. In a first compression act, the coil is pre-compressed in the direction of the coil axis, wherein the strands of the winding wire are compacted and the individual coil turns are pressed against one another. After the first act, the pre-compressed coil is removed from the dummy winding former. The at least one fixing tape is then wound in a flexible, as yet uncured state, around the coil removed from the dummy winding former. The coil provided with the at least one fixing tape is then reinserted into the dummy winding former.

In a second compression act, the coil is once again compressed in the direction of the coil axis, wherein the individual coil turns are pressed against one another, and the coil assumes a final compacted state. The fixing tape cures or is cured when the coil is in the final compacted state, and the compacted coil fixed by the cured fixing tape is removed from the dummy winding former.

Compression in two acts takes account of the fact that, if the pre-compressed coil is removed from the dummy winding former in order to apply the at least one fixing tape, the coil already spreads out again to a small extent. After the application of the at least one fixing tape, it is therefore necessary to recompact or recompress the coil, in this case with the fixing tape applied. Once the coil is then in the final compacted state, the fixing tape cures or is cured, e.g., by increasing the temperature. The finally compacted coil is fixed by the cured fixing tape and attains stability of shape. It may then be removed from the dummy winding former.

Alternatively, compression takes place in just one act. Provision is made here whereby, after the winding of the winding wire and before compression, the at least one fixing tape is wound in a flexible, as yet uncured state, around the as yet uncompressed coil (in this case, provision may be made for the wound winding wire to be removed from the dummy winding former, provided with the fixing tape and then placed on the dummy winding former again). The coil with the at least one fixing tape is then compressed in the direction of the coil axis, wherein the strands of the winding wire are compacted and the individual coil turns are pressed against one another, with the result that the coil assumes a compacted state. The fixing tape cures or is cured (e.g., by increasing the temperature and then cooling) only when the coil is in the compacted state. Further, the compacted coil fixed by the cured fixing tape is removed from the dummy winding former.

In this example, the fixing tape is thus applied to the coil turns even before compression. The compression and compaction of the coil has the effect that the fixing tape is arranged relatively loosely on the coil turns. Nevertheless, fixing of the coil turns or coil in the compacted state is achieved since the fixing tape cures and, as a result, may perform the function of a coil fixing despite any formation of loops or the like.

In another example, the individual wires of the strand are each coated with a baked enamel coating, wherein the baked enamel coating cures or is cured together with the insulating tape. Here, curing is once again effected by an increase in temperature and subsequent cooling, for example. The curing of the baked enamel together with the insulating tape provides that, in the compacted state, the coil turn also achieves strength and stability of shape on the inside in the region of the strand.

In certain examples, the winding wire is compressed to a rectangular cross section.

In another example, after the application of the coil to the winding former of the tooth-wound coil, the coil is impregnated, wherein the turn insulation and the strand of the winding wire are impregnated with a resin. In this case, the resin is absorbed by the porous turn insulation and additionally fills the remaining interspaces between the individual strands.

### BRIEF DESCRIPTION OF THE DRAWINGS

The disclosure is explained in greater detail below by a plurality of exemplary embodiments with reference to the figures.

FIG. 1 shows schematically the construction of an example of a winding wire, which includes a strand with a multiplicity of individual wires and a turn insulation.

FIG. 2 shows, in perspective illustration, one embodiment of an electrical coil, which has a plurality of coil turns, wherein the coil turns are each wound in four portions with a fixing tape which envelops and geometrically fixes the coil turns.

FIG. 3 shows the coil from FIG. 2 in a view from the rear.

FIG. 4 shows schematically an example of a dummy winding former used in a method for producing a coil according to FIGS. 2 and 3, wherein a winding wire including a strand is wound onto the dummy winding former to provide a coil that has a multiplicity of coil turns.

FIG. 5 shows a perspective illustration of one example of an individual tooth of a stator of a permanent magnet synchronous motor including a coil.

FIG. 6 shows a flow chart of an example of a method for producing an electrical coil according to FIGS. 2 and 3.

### DETAILED DESCRIPTION

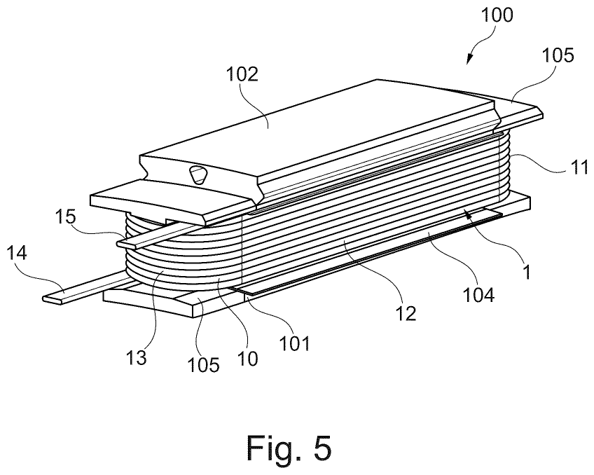

For a better understanding of the background, an example coil is described on the basis of FIG. 5.

FIG. 5 shows, in a perspective view, one example of a coil in the form of an individual tooth-wound coil 1, which is wound onto a coil former, wherein the individual tooth-wound coil 1 and the coil former form an individual tooth 100. The coil former includes a sheet-metal front plate 101, a sheet-metal backplate 102, and a winding former (not visible in FIG. 5), which extends between the sheet-metal front plate 101 and the sheet-metal backplate 102 and around which a winding wire 10 is wound that forms the coil 1. In this case, the coil former forms a slot between the sheet metal front plate 101 and the sheet-metal backplate 102. An insulating paper 104 may be arranged between the winding former and the winding wire 10. The winding former may have a cuboidal main body, which includes a stack of rectangular, enamel-insulated laminations. An end winding support (not visible in FIG. 5) including a plastic, which provides the required rounding for the winding wire 10, is mounted on each of the ends of the cuboidal laminated winding former.

As may be seen in FIG. 5, the winding wire 10 forms a multiplicity of turns 11, with each turn forming straight longitudinal portions or legs 12 and, at their ends, additional portions 13 that, in the exemplary embodiment illustrated, are rounded and in each case placed around an end winding support over 180°. Here, the winding wire 10 is guided without kinks in the rounded portions 13.

In the example illustrated, the winding wire 10 is formed by a copper flat conductor, which is wound onto the winding former. Two contact ends 14, 15 of the winding wire 10 project on one side. They are used for electrical contacting of the winding wire 10. Alternatively, the winding wire 10 may be formed by a strand.

As illustrated in FIG. 5, the sheet-metal front plate 101 has a smaller width than the sheet-metal backplate 102. This makes it possible to combine a plurality of individual teeth 100 to form an annular stator of an electrical machine, e.g., of a permanent magnet synchronous motor, wherein the interconnected sheet-metal backplates 102 form an outer stator ring of such a stator.

Particularly in the case where the winding wire 10 is formed by a strand, it is desirable to increase the copper fill factor of the winding wire 10 and hence of the coil. In this case, the winding wire is not wound directly onto the winding former of the individual tooth 100, but instead is wound onto a dummy winding former. The coil formed in this process is compacted and fixed and then mounted as a whole as an air core coil on the individual tooth 100, for which purpose the geometry of the individual tooth 100 is adapted accordingly, and this tooth has removable elements, for example. For example, provision may be made for the sheet-metal front plate 101 to be of removable design in order to enable the wound coil 1 to be mounted on the winding former of the individual tooth 100.

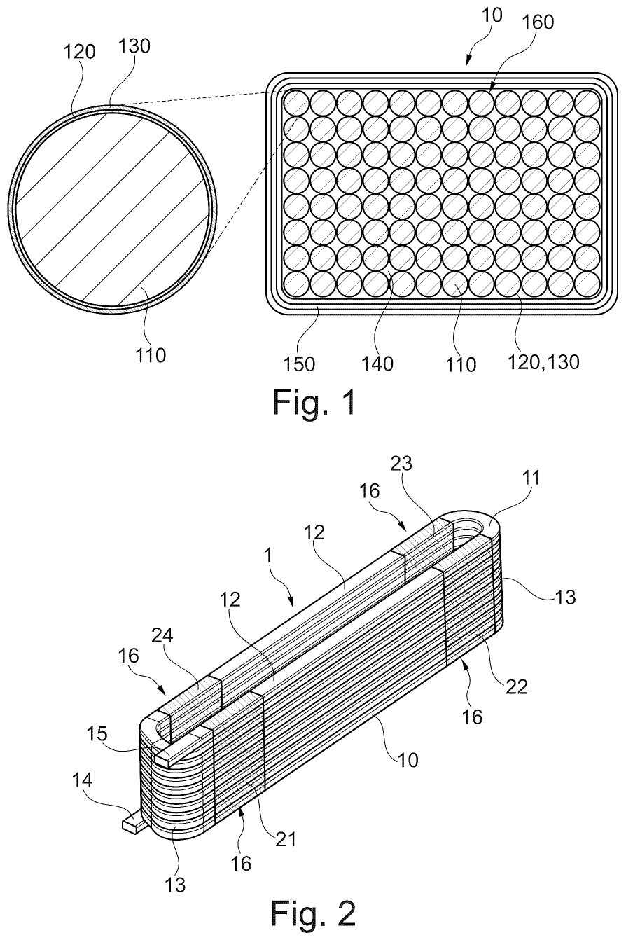

FIG. 1 shows schematically the construction of a winding wire 10, which is wound into a plurality of coil turns that form a coil. The winding wire includes a strand 160 that includes a multiplicity of thin, twisted individual wires 110. The individual wires 110 have a circular cross section. Between the individual wires 110 there is a cavity or a free volume 140. The strand 160 including the individual wires 110 is surrounded by a turn insulation 150.

The turn insulation 150 includes a porous, compressible material that is electrically insulating. The material is configured in such a way that the property of electrical insulation is maintained even after compression of the material. The turn insulation 150 includes a woven fabric, a non-crimp fabric, or a non-woven fabric on the basis of polymers or organic fibers, for example.

As illustrated on the left on an enlarged scale in FIG. 1, each individual wire 110 is provided with an insulation 120, which electrically insulates the individual wire 110. Adjoining the insulation 120 is a coating including baked enamel 130. The coating of baked enamel 130 is suitable and provided for melting at elevated temperature and then curing.

FIG. 2 shows an electrical coil 1 in the finally produced state. The coil 1 includes a multiplicity of coil turns 11, which are formed by a winding wire 10. Each coil turn 11 includes two straight legs 12 and, at the ends thereof two further portions 13, which in the exemplary embodiment illustrated are rounded but, alternatively, may be of straight design, for example. A voltage is applied across the coil 1 via the contact ends 14, 15 of the winding wire 10, which project on one side of the coil 1.

The coil 1 furthermore includes four fixing tapes 21-24, which are each wound around the coil turns 11 in a portion 16. The fixing tapes 21-24 include a cured composite material. They were cured in a state in which the coil 1 was in a compressed state, such that they geometrically fix and provide the stability of shape of the coil 1 in the compressed state of the coil.

In the exemplary embodiment illustrated, two fixing tapes 21-24 are provided in the region of each straight leg 12, said tapes being arranged at mutually opposite ends of the legs 12 and each winding around the coil turns 11 locally in the portions 16 and geometrically fixing them. This arrangement of the fixing tapes may be taken to be only illustrative.

FIG. 3 shows the coil 1 from FIG. 2 in a front view or rear view. A coil axis 4 is additionally illustrated here.

The coil 1 in FIGS. 2 and 3 includes a winding wire 10, which is constructed as per FIG. 1 and accordingly includes a strand 160 with individual wires 110 and a turn insulation 150. To provide a compacted coil 1, there is a need for a production method in which the strands 160 of the winding wire 10 are compacted. This takes place under pressure, wherein the turn insulation 150 is also compressed, with the result that the internal volume of the winding wire 10 is reduced overall during the pressing process and, accordingly, the copper fill factor of the winding wire 10 is increased. In the method for producing the coil 1, it is furthermore envisaged that the individual coil turns 11 are pressed against one another, thus ensuring that there are no cavities between them. During the pressing process, the winding wire 10 also receives its final shape, which is rectangular in the exemplary embodiment illustrated, although not necessarily so.

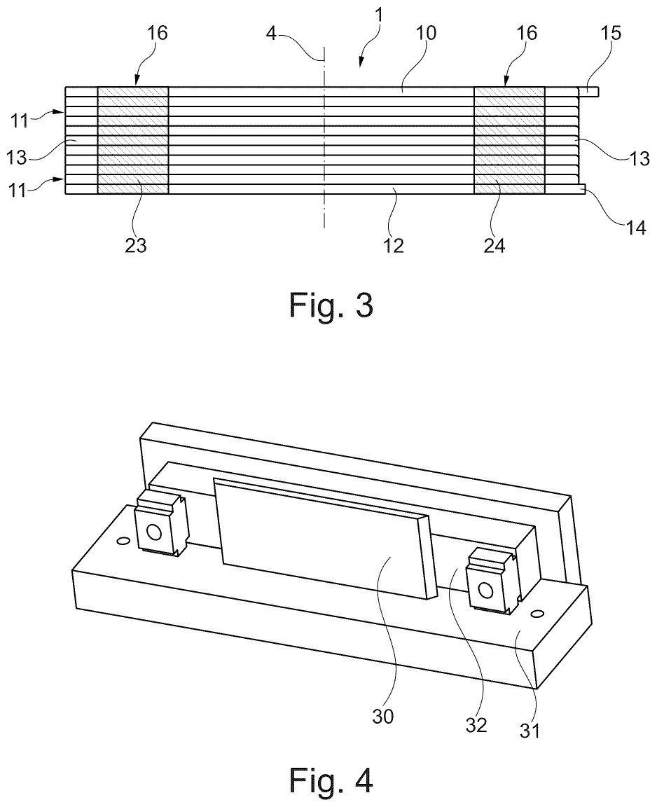

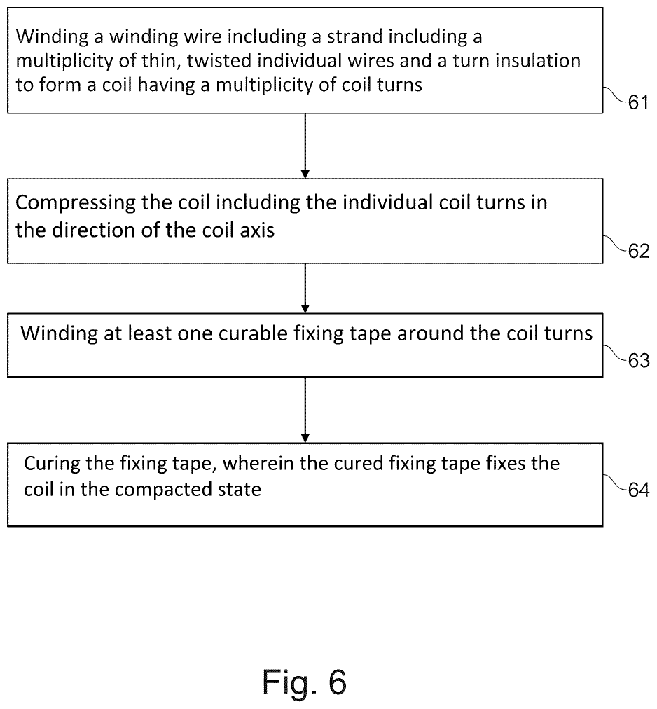

The production method is explained by way of example below with reference to FIGS. 4 and 6.

According to act 61 in FIG. 6, a winding wire including a strand including a multiplicity of thin, twisted individual wires and a turn insulation is wound to form a coil having a multiplicity of coil turns. During this process, the winding wire is wound onto a dummy winding former. Such a dummy winding former is illustrated by way of example in FIG. 4. This shows a dummy winding former 30 that is of cuboidal design and, in the exemplary embodiment illustrated, has a small depth. The dummy winding former 30 is located on a platform 31 and is delimited by side walls 32.

According to act 62, the coil including the individual coil turns is compressed in the direction of the coil axis (see coil axis 4 in FIG. 3). This is accomplished by moving parallel press plates (not illustrated in FIG. 4) toward one another. For example, an upper press plate is moved in the direction of the platform 31, which here forms a lower press plate.

During the compression of the coil, as explained, the strands of the winding wire are compacted and the individual coil turns are pressed against one another. In addition to compression in the direction of the coil axis or in the vertical direction, compression may also take place in a horizontal direction by suitable press plates.

According to act 63, at least one curable fixing tape (e.g., corresponding to the fixing tapes 21-24 in FIGS. 2 and 3) may be wound around all the coil turns. At this point in time, the fixing tape is not yet cured but is flexible, and therefore the fixing tape may be wound around the coil turns without problems. The fixing tape may be a curable tape that is not adhesive at room temperature, but melts with a high viscosity at an elevated temperature, and then cures. Such a curable tape is also referred to as a “B-stage tape.” The winding of the at least one curable fixing tape around the coil turns may take place before or after compression, as will be explained below.

According to act 64, the fixing tape is cured, wherein the cured fixing tape fixes the coil in the compacted state. The curing of the fixing tape thus takes place at a point in time at which the coil is in the compacted or compressed state. It is thereby possible by the cured fixing tape to maintain the compressed state of the coil and to avoid spreading out of the coil turns after the compression pressure is ended.

To achieve curing of the fixing tape, the temperature is increased, for example, with the result that the fixing tape melts. Such a temperature increase also has the effect that the baked enamel 130 surrounding the individual wires 110 of the strand 160 melts (FIG. 1). Upon cooling, the fixing tape cures, and the baked enamel also cures. The cured baked enamel has the effect of fixing the elevated proportion of copper in the strand achieved by the pressing process. The volume of the strand may no longer increase.

After the curing of the fixing tape, the coil is removed from the dummy winding former 30 and applied to a winding former of an individual tooth 100 as per FIG. 5. During this process, the prefabricated air core coil is inserted into a slot in the winding former. Finally, the coil is impregnated with an impregnating resin, wherein the impregnating resin fills the porous turn insulation 150 and, via the latter, also the free volume 140 (FIG. 1) of the strand 160.

In one example, the winding of the fixing tape around the coil turns takes place after a first compression process, wherein compression takes place in a total of two acts. In this case, the coil is first pre-compressed on the dummy winding former 30. The compressed coil is then removed from the dummy winding former 30 in order to apply the at least one fixing tape. After the removal of the compressed coil from the dummy winding former 30 and before the application of the at least one fixing tape, the coil spreads out to a certain extent, thus losing some of its compaction. Provision is therefore made, after the application of the at least one fixing tape, to place the coil on the dummy winding former 30 again and to compress the coil again in a second compression act. The coil then assumes a final compacted state. Only after this state has been achieved does the fixing tape cure or is it cured by increasing the temperature. With the curing of the fixing tape, the fixing tape secures the finally compacted state of the coil. The compacted coil fixed by the cured fixing tape may then be removed from the dummy winding former.

Alternatively, compression of the coil may take place in one act. In this case, the fixing tape is wound around the coil turns before compression. For this purpose, provision may be made for the coil to be removed from the dummy winding former after the winding process, for the fixing tape to be applied, and then for the coil to be fed back to the dummy winding former. The coil is then compressed together with the at least one fixing tape, with the result that the coil assumes a compacted or compressed state. In the compressed state, the fixing tape then cures or is cured, for example, by supplying heat for melting and subsequent curing. After the curing of the fixing tape, the coil with the cured fixing tape may be removed from the dummy winding former. Since the height of the coil is reduced during the pressing process (e.g., the height reduction may be up to 50%), the fixing tape does not fit tightly on the coil turns after compression and before curing and may form creases. This is remedied by the subsequent heating and curing of the fixing tape.

The disclosure is not limited to the embodiments described above and different modifications and improvements may be made without deviating from the concepts described here. It is furthermore pointed out that any of the features described may be used separately or in combination with any other features, provided that they are not mutually exclusive. The disclosure extends to and includes all combinations and sub-combinations of one or more features which are described here. If ranges are defined, these ranges therefore include all the values within these ranges as well as all the partial ranges that lie within a range.

1. An electrical coil comprising:
a winding wire that is wound to form a plurality of coil turns,
wherein the winding wire has a strand that comprises a multiplicity of twisted individual wires, and wherein the strand is sheathed with a turn insulation,
wherein the plurality of coil turns is wound in at least one portion with a fixing tape that, in a compressed state of the electrical coil, locally envelops and geometrically fixes the plurality of coil turns,
wherein the turn insulation comprises a porous, compressed material that is electrically insulating.
wherein the turn insulation and the strand are impregnated with a resin,
wherein the resin fills the turn insulation and a free volume of the strand via the turn insulation, and
wherein the electrical coil is configured to be applied to a winding former of an individual tooth of a stator.

2. (canceled)

3. The electrical coil of claim 1, wherein each individual wire of the strand is provided with an insulation.

4. The electrical coil of claim 1, wherein each individual wire of the strand is coated with a baked enamel coating.

5. The electrical coil of claim 1, wherein the plurality of coil turns is locally fixed by a plurality of fixing tapes that are spaced apart.

6. The electrical coil of claim 1, wherein the plurality of coil turns is locally enveloped by the fixing tape in a region of a leg of the electrical coil.

7. (canceled)

8. The electrical coil of claim 1, wherein the turn insulation comprises a woven fabric, a non-crimp fabric, or a non-woven fabric.

9. (canceled)

10. The electrical coil of claim 1, wherein the winding wire has a rectangular cross section.

11. An electrical machine comprising:
a rotor; and
a stator, comprising a plurality of coils,
wherein each coil of the plurality of coils is applied to a winding former of an individual tooth of the stator.
wherein each coil of the plurality of coils comprises a winding wire that is wound to form a plurality of coil turns,
wherein the winding wire has a strand that comprises a multiplicity of twisted individual wires,
wherein the strand is sheathed with a turn insulation,
wherein the plurality of coil turns is wound in at least one portion with a fixing tape that, in a compressed state of the respective coil, locally envelops and geometrically fixes the plurality of coil turns,
wherein the turn insulation comprises a porous, compressed material that is electrically insulating.
wherein the turn insulation and the strand are impregnated with a resin, and
wherein the resin fills the turn insulation and a free volume of the strand via the turn insulation.

12. A method for producing an electrical coil, the method comprising:
winding a winding wire having a strand that comprises a multiplicity of twisted individual wires and is provided with a turn insulation to form a coil having a multiplicity of coil turns, wherein the turn insulation comprises a porous, compressible material that is electrically insulating, wherein the turn insulation maintains an electrical insulation after compression of the porous, compressible material, and wherein the winding wire is wound onto a dummy winding former;
compressing the coil at least in a direction of a coil axis, wherein, the strand of the winding wire is compacted and individual coil turns of the multiplicity of coil turns are pressed against one another, such that the assumes a compacted state;
winding at least one curable fixing tape around the multiplicity of coil turns before or after the compressing of the coil, wherein the at least one curable fixing tape comprises a curable composite material:
curing the at least one curable fixing tape to provide a cured fixing tape, wherein the cured fixing tape fixes the coil in the compacted state;
removing the coil from the dummy winding former; and
applying the coil to a winding former of an individual tooth, wherein the winding former of the individual tooth comprises a laminated core, and the coil is inserted into a slot of the laminated core; and
impregnating the coil, wherein the turn insulation and the strand of the winding wire are impregnated with a resin, and wherein the resin fills the turn insulation and a free volume of the strand via the turn insulation.

13. (canceled)

14. The method of claim 12, wherein the compressing of the coil takes place in two compression acts,
wherein in a first compression act, the coil is pre-compressed in the direction of the coil axis, wherein the strand of the winding wire is compacted and the individual coil turns are pressed against one another,
wherein, after the first compression act, the pre-compressed coil is removed from the dummy winding former,
wherein the at least one curable fixing tape is then wound in a flexible, as yet uncured state, around the coil removed from the dummy winding former,
wherein the coil provided with the at least one curable fixing tape is then reinserted into the dummy winding former,
wherein, in a second compression act, the coil is once again compressed in the direction of the coil axis, wherein the individual coil turns are pressed against one another, and the coil assumes a final compacted state,
wherein the at least one curable fixing tape cures or is cured when the coil is in the final compacted state, and
wherein the coil in the final compacted state and fixed by the cured fixing tape is removed from the dummy winding former.

15. The method of claim 12, wherein the compressing of the coil takes place in one compressing act,
wherein after the winding of the winding wire and before compression, the at least one curable fixing tape is wound in a flexible, as yet uncured state, around an uncompressed coil,
wherein the coil with the at least one curable fixing tape is then compressed in the direction of the coil axis,
wherein the strand of the winding wire is compacted and the individual coil turns are pressed against one another such that the coil assumes the compacted state,
wherein the at least one curable fixing tape cures or is cured only when the coil is in the compacted state, and
wherein the coil in the compacted state and fixed by the cured fixing tape is removed from the dummy winding former.

16. The method of claim 12, wherein each individual wire of the multiplicity of twisted individual wires of the strand is coated with a baked enamel coating, and
wherein the baked enamel coating cures or is cured together with the at least one curable fixing tape.

17. The method of claim 12, wherein the winding wire is compressed to a rectangular cross section.

18. (canceled)

19. The method of claim 12, wherein, during the compressing of the coil, the coil is also compressed perpendicularly to the coil axis.

20. (canceled)

21. The electrical coil of claim 1, wherein the individual tooth of the stator comprises a sheet-metal front plate, a sheet-metal back plate, and a winding former extending between the sheet-metal front plate and the sheet-metal back plate, and
wherein the electrical coil is configured to be inserted into a slot of the winding former.
